(19) United States
(12) Patent Application Publication
(10) Pub. No.: US 2025/0252166 A1
(43) Pub. Date: Aug. 7, 2025

(54) METHOD FOR REGISTERING A CONTROL DEVICE OF A VEHICLE WITH A SERVICE INFRASTRUCTURE

(71) Applicant: MERCEDES-BENZ GROUP AG, Stuttgart (DE)

(72) Inventors: Mark GERBAN, Hamburg (DE); Martin KEPPLER, Oberreichenbach (DE); Patrick BECKER, Osnabrück (DE); Jörg ECHARD, Sindelfingen (DE)

(21) Appl. No.: 18/880,879

(22) PCT Filed: Jun. 28, 2023
(86) PCT No.: PCT/EP2023/067735

§ 371 Date: Jan. 3, 2025

(30) Foreign Application Priority Data
Jul. 5, 2022 (DE) 10 2022 002 454.3

(51) Int. Cl. G06F 21/32; G06Q 20/38; G06Q 20/40; G07C 5/00

(52) U.S. Cl. CPC G06F 21/32; G06Q 20/3827; G06Q 20/40145; G06Q 2240/00; G07C 5/008

(57) ABSTRACT

The control device has a UID, which it supplies to the service infrastructure. A vehicle data set, containing the UID, of the vehicle is known and accessible via a backend service of the vehicle manufacturer. A user enters into a service contract for a service with a service provider via a software interface of an application by the backend service. The control device supplies the UID to the service infrastructure as a reference or as a hashID created temporarily by means of a time-based one-time password algorithm. The UID is read out during production of the vehicle via a diagnostic service and is permanently stored in the vehicle data set of the vehicle. The backend service determines the UID of the control device installed in the vehicle, required for entering into the service contract, from the vehicle data set and automatically adopts it.

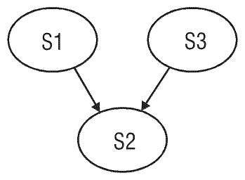

### BACKGROUND AND SUMMARY OF THE INVENTION

Exemplary embodiments of the invention relate to a method for registering a control device of a vehicle with a service infrastructure.

It is known to offer services for paying tolls and vignettes while driving (for example toll gate system—TGS) on a control device in a vehicle. To pay, the control device sends a unique string (UID) to the infrastructure, by which the control device can be identified by a service infrastructure.

In order to actually pay the toll by means of the service, the customer has to enter into a service contract with a service provider, in the process confirming the terms and conditions and storing a payment method (for example credit card details). This service contract is handled via a backend of the vehicle manufacturer in order to generate revenue share as reimbursement for the vehicle manufacturer.

Additionally, the service provider has to recognize the UID of the control device installed in the customer vehicle in order to be able to assign the billing information of the service infrastructure (amount and UID) to a payment account of the customer.

The assignment of the UID of the control device present in the customer vehicle to the payment account is done manually by the customer in the prior art. The following methods are used for this:
Reading and typing an ID printed on the control device or attached to the control device.
Scanning a barcode or 2D code (e.g. QR code or 2D barcode) printed on the control device or displayed on a display unit and/or transmitting the same by means of a radio link (for example Bluetooth), for example by means of an app on a smartphone.

DE 10 2019 205 362 A1 describes a method for authenticating a vehicle to a service unit by means of a central computing unit external to the vehicle. In this case, an initial value is transmitted from the service unit to the authentication unit and, depending on the initial value, a request command is read out from a request table by the authentication unit and is output to an interface of the vehicle. The authentication unit receives an output value, created as a response, from the interface and calculates a vehicle test value from the output value. The vehicle test value and the initial value are transmitted to the central computing unit. Depending on the initial value, a characteristic value is read out from a characteristic value table by the central computing unit and a further vehicle test value is calculated. A predetermined enable signal is sent to the service unit by the central computing unit when the vehicle test value is in accordance with the other vehicle test value.

Exemplary embodiments of the invention are directed to a novel method for registering a control device of a vehicle with a service infrastructure.

According to one aspect of the present invention, it is provided in a method for registering a control device of a vehicle with a service infrastructure that the control device has a UID that it supplies to the service infrastructure, wherein a vehicle data set, containing the UID, of the vehicle is known and accessible via a backend service of the vehicle manufacturer, wherein a user enters into a service contract for a service with a service provider via a software interface of an application by means of the backend service, wherein the control device supplies the UID to the service infrastructure as a reference or as a hashID created temporarily by means of a time-based one-time password algorithm (TOTP), wherein the UID is read out during production of the vehicle via a diagnostic service and is permanently stored in the vehicle data set of the vehicle, wherein the backend service determines the UID of the control device installed in the vehicle, required for entering into the service contract, from the vehicle data set and automatically adopts it.

According to one aspect of the present invention, it can alternatively or additionally be provided that the control device supplies the UID to the service infrastructure as a reference or as a hashID, created temporarily by means of a time-based one-time password algorithm, during operation of the vehicle via the software interface.

In one embodiment, a biometric credential of the user is available or is created during a registration process via at least one vehicle sensor, wherein the biometric credential is linked to at least one identifier as a hash value for the service and has been or is saved in a local storage device or in a cloud, wherein the service is only activated in the vehicle when the authorized user is recognized as being present and/or active in the vehicle via biometric authentication.

In one embodiment, biometric authentication of the user is carried out at the user's request and is compared with the credential saved in the cloud, wherein the user is authorized to use the service in a further vehicle, meaning that no further registration is required there.

In one embodiment, for entering into the service contract, the user accesses the backend service via a central instrument in the vehicle, via a smartphone or via a device in a service operation which has network access to the vehicle data set.

In one embodiment, the at least one vehicle sensor is formed as a fingerprint scanner, a retinal scan sensor, a face scan sensor, a body scan sensor, a lidar, and/or a sensor system for voice authentication.

In one embodiment, the service is a toll service or a vignette service.

In one embodiment, the hashID is linked to the biometric credential as a fixed identifier.

In one embodiment, the control device supplies the service infrastructure with further data in addition to the UID, in particular a vehicle identification number, a vehicle license plate, a country or state in which the vehicle is registered, a vehicle type, vehicle dimensions, a permissible vehicle weight, payment details, and/or payment account details.

Due to the present invention, some manual processes can be eliminated by registering toll services from third party suppliers. Simultaneously, the security is increased for vehicles and customer services by using an associated biometric identifier during toll payment. The biometric data itself can be saved in a local storage device or in the cloud, wherein a customer can access their toll payment in their own vehicle or a secondary vehicle, which is equipped with a toll system, without requiring a further registration process.

The present invention is not limited to TGS but can also be used for other control devices and services.

The invention is also not limited to just the UID, but can likewise include other data points necessary for service operation, for example: vehicle identification number (VIN), license plate, country and/or federal state of the license plate, vehicle type, vehicle dimensions, permissible vehicle weight, payment details and/or payment account details (for example PayPal account, WeChat, Alipay, mobile operator network payment, credit cards, prepayment, IBAN, virtual credit cards). When entering into the service contract, only the missing data points are determined manually; all of the available data points are automatically supplied by the method according to the invention.

In the method according to the invention, the authentication is not carried out via a driver's license or a physical card, but can take place by recognizing the driver from a biometric perspective at the time of the drive (for example by voice recognition, body and/or face scan, biometric features, in-cabin lidar etc.). Known approaches require an authentication scheme which does not contain any biometric authentication but requires physical identity cards or payment information which is saved and linked to a profile. If the profile is not turned off, the profile can be used to pay anywhere that allows unauthorized use. Since the present invention uses biometric authentication each time the vehicle is used for a journey, this significantly increases the security, wherein the biometric feature itself can be sent as a random hash value or as a real biometric image to a cloud service for authentication purposes or to a local storage device for comparison purposes.

According to one embodiment, it is provided that the customer is able to port their profile in a cloud state to a second vehicle via a biometric profile. For this purpose, the second vehicle itself features a biometric reading device with which the biometric profile saved in the cloud and its toll service registration information can be linked for use in the second vehicle, without requiring further registration processes or authentications for customer vehicles.

The manual processes required in the prior art are automated by means of the invention, so that they run fully automatically and therefore interaction is no longer required. The simpler device results in a lower dropout rate when entering into contracts, in more contracts and therefore also more sales. This also increases customer satisfaction and improves the customer experience.

Exemplary embodiments of the invention are explained in more detail in the following using the drawing.

### BRIEF DESCRIPTION OF THE SOLE DRAWING FIGURE

Here:

The sole drawing figure shows a schematic view of a method for registering a control device with a service provider.

### DETAILED DESCRIPTION

The sole drawing figure is a schematic view of a method for registering a control device with a service provider.

According to the present invention, a control device in a vehicle, which supplies its UID to an infrastructure, supplies the UID via a diagnostic service.

In a step S1, the UID of the control device is read out during production of the vehicle, for example by means of an end-of-line tester via the diagnostic service, and is stored permanently in a vehicle data set of the vehicle.

The vehicle data set of the vehicle and thus the UID of the control device is known via a backend service of the vehicle manufacturer.

In a step S2, a user of the vehicle enters into a service contract with a service provider by means of the backend service. In this case, the backend determines the UID of the control device, installed in the vehicle, required for entering into the service contract and automatically adopts it. Alternatively or additionally, service activation can take place completely or partially via any device, for example in a service mode, which has network access to the vehicle data set.

Alternatively or additionally, in step S2, the control device, which supplies the UID to the infrastructure, supplies the UID during operation of the vehicle (“ignition is on, control device active”) via a software interface of an application, by means of which the service registration can take place or the service contract can be entered into. The application can, for example, be an app running on a central instrument (also known as a head unit) of the vehicle.

If the user enters into the service contract with the service provider via an application during the vehicle operation by means of the back end service, the application can request the UID of the control device, installed in the customer vehicle, in order to complete the service contract from the vehicle directly and to automatically adopt it.

At this time, a biometric credential of the user is available, which if necessary can be read in a step S3 during a registration process via at least one vehicle sensor (for example via a fingerprint scanner, a retinal scan, a face scan, a body scan, via lidar, and/or via voice authentication), which is linked to the registered service, wherein the biometric credential, in particular a biometric image, itself is linked as a hash value and saved in a local storage device or in the cloud. In particular, the biometric hash value is linked to identifiers for the service provider. This means that the service can only be reached by a biometric scan and/or a biometric authentication when the authorized user is present and/or active in the vehicle. Toll payments can thus only take place via a payment network when biometric authentication is available. When the biometric data is located in the cloud and the user decides to switch to a second vehicle, then the at least one vehicle sensor of the vehicle can scan and authorize the customer to activate and use the toll service for the second vehicle without further user registration, whereby a seamless usability effect is enabled.

Alternatively or additionally, the transmitted reference to a UID is not a fixed toll payment system-specific reference (the UID itself), but is an only temporarily derived hashID which changes over time from the then secret UID (method according to TOTP). This hashID can also be linked to the biometric credential as a further fixed identifier in order to increase customer security. The biometric details and/or security details can also be used to increase the payment authentication standards, for example PSD2, 3D Secure, etc.

In an exemplary embodiment, a determined hardware and/or software component (for example from a TPM module-trusted platform module), which is contained in the control device, for example a toll control unit, and can be used for authentication purposes in credit card networks, can be assigned to the payment account and transmitted (for example for delegated authentication, two-factor authentication, multi-factor authentication, etc.).

The manual process previously required in the prior art is automated by the invention so that it runs fully automatically and therefore no interaction is necessary. The simpler device results in a lower cancellation rate when entering into contracts, in more contracts and therefore also in more sales. The biometric elements increase security. The user is able to carry their toll profile via a cloud profile and access it from any vehicle, so that access to their toll system can be made simpler and more secure without the additional use of devices (for example mobile telephones, etc.).

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method, comprising:
supplying, by a control device of a vehicle to a service infrastructure, a UID, which it supplies to the service infrastructure, wherein a vehicle data set, containing the UID, of the vehicle is known and accessible via a backend service of a vehicle manufacturer;
entering, by a user, a service contract for a service with a service provider via a software interface of an application provided by the backend service; and
determining, by the backend service, the UID of the control device installed in the vehicle from the vehicle data set and automatically adopting the UID determined from the vehicle data set,
wherein the control device supplies the UID to the service infrastructure as a reference or as a hashID created temporarily by a time-based one-time password algorithm,
wherein the UID is read out during production of the vehicle via a diagnostic service and is permanently stored in the vehicle data set of the vehicle, and
wherein the UID of the control device is required to enter into the service contract.

12. The method of claim 11, wherein the control device supplies the UID to the service infrastructure as the reference or as the hashID during operation of the vehicle via the software interface.

13. The method of claim 11, wherein a biometric credential of the user is available or is created during a registration process via at least one vehicle sensor, wherein the biometric credential is linked to at least one identifier for the service as a hash value and has been or is saved in a local storage device or in a cloud, wherein the service is only activated in the vehicle when the user is recognized as being present or active in the vehicle via biometric authentication.

14. The method of claim 13, wherein biometric authentication of the user is performed at the user's request and is compared with the credential saved in the cloud, wherein the user is authorized to use the service in a further vehicle.

15. The method of claim 11, wherein for entering into the service contract, the user accesses the backend service via a central instrument in the vehicle, via a smartphone, or via a device in a service operation having network access to the vehicle data set.

16. The method of claim 13, wherein the at least one vehicle sensor is a fingerprint scanner, a retinal scan sensor, a face scan sensor, a body scan sensor, a lidar, or a voice authentication sensor system.

17. The method of claim 11, wherein the service is a toll service.

18. The method of claim 11, wherein the hashID is linked to the biometric credential as a fixed identifier.

19. The method of claim 11, wherein the control device supplies the service infrastructure with further data in addition to the UID, in particular a vehicle identification number, a vehicle license plate, a country or state in which the vehicle is registered, a vehicle type, vehicle dimensions, a permissible vehicle weight, payment details, or payment account details.
